(19) United States
(12) Patent Application Publication
(10) Pub. No.: US 2007/0214331 A1
(43) Pub. Date: Sep. 13, 2007

(54) Selectable mass storage system

(76) Inventor: Gordon John Murphy, Glenview, IL (US)

Correspondence Address: GORDON J. MURPHY, 638 GARDEN COURT, GLENVIEW, IL, 60025-4105, US

(21) Appl. No.: 11/372,411

(22) Filed: Mar. 10, 2006

(51) Int. Cl. G06F 12/00

(52) U.S. Cl. 711/163

(57) ABSTRACT

Switching apparatus is used in combination with a multiplicity of mass storage units to provide a user of a digital computer with privacy from other local users and from users on a connected network. When the computer is connected to the network, the private files are protected from computer viruses, worms, and other pieces of destructive code. When the computer is not connected to a network, various local users can maintain their own programs and data files in complete privacy from other local users. A given digital computer can be converted into the equivalent of two digital computers, each of which can be provided with its own operating system. Hardware-controlled dual booting is made possible also.

### BACKGROUND OF THE INVENTION

1. Field of the Invention

The present invention relates generally to the selective isolation of a first set of mass storage units in a digital computer or other digital system from a second set of mass storage units in the same digital computer or other digital system so that information transfer between mass storage units in the first set and mass storage units in the second set is prevented. Thus, when one set of mass storage units is selected or connected, a second set of mass storage units is deselected or disconnected. For example, the first set may consist of a single hard disk and the second set may consist also of a single hard disk.

In another embodiment of this invention, for example, the first set again consists of a single hard disk, but the second set may consist of several subsets. Each of those subsets consists of a single hard disk. The disks in the second set are interconnected in such a way that any member of the second set can be selected and connected to the computer with the result that that disk becomes a new first set while the disk that formerly constituted the first set is disconnected and relegated to a newly formed second set, replacing the newly enabled disk. In other embodiments the first set, as well as the second set, may comprise more than one member.

The present invention relates also generally to the booting of a digital computer to operate under the control of an operating system selected from among multiple operating systems stored on distinct hard disk drives. The capability to boot the computer in such a way may be desirable for any of the following reasons, among others:
a) the programs to be stored in the computer may exceed the capacity of a single hard disk, and it is desired to have the operating system controlling a program resident on the same disk as that program;
b) it is desired that access to certain programs be denied to certain users of the computer; and
c) it is desired to have a distinct operating system stored on each distinct hard disk in the computer, to allow use of different operating systems at different times.

2. Description of the Prior Art

The use of multiple disks in a digital computer is not new. Multiple disks have been used to increase the storage capacity of a computer beyond what is possible with a single disk; in such applications, all disks are connected and operational whenever the computer is in operation. Software-controlled dual booting of digital computers has been employed to permit selection of a particular hard disk or partition from which to boot an operating system in computers in which operating systems have been installed on multiple hard disks and/or partitions. The selection has been made by software means, and all hard disks and/or partitions have been connected and accessible by the partitioning software after the operating system has been booted.

Multiple disks have been used also to increase the reliability of a computer, by providing multiple copies of the information stored in the computer on separate disks. In such a system, if one disk should fail, the stored data can be retrieved from another disk. In such applications, also, all disks are connected and operational whenever the computer is in operation.

RAID (Redundant Array of Inexpensive Disks) systems have been used to enhance performance in a number of ways. Disk striping, a process of distributing data reads and writes across multiple disks, reduces the effect of head seek time on speed of data transfer. Disk mirroring and duplexing provide protection against loss of data by writing duplicate data to different disks. Error correcting code in a RAID provides some protection against data loss by storing a check sum on the disk. Again, all disks are connected and operational whenever the computer is in operation.

In all of these previous multiple disk systems, all disks are connected concurrently, and data and programs stored on one disk can be transferred to another disk. Consequently, a destructive program or piece of code that is admitted to one disk can contaminate all disks in the system.

In a companion patent application Ser. No. 11/065,552, which is incorporated herein by reference, there is disclosed a system for isolating mass storage devices by enabling and disabling them. The devices are always connected, through their data lines, but they are enabled and disabled by use of control lines or power lines. In such a system one or more of the mass storage devices are enabled at a given time and one or more of the mass storage devices are disabled.

The apparatus disclosed herein differs in that it provides isolation of mass storage units that are always fully enabled, by connecting and disconnecting them. Also encompassed by this invention is apparatus for enabling/disabling some mass storage units and connecting/disconnecting others.

The switching methods disclosed in patent application Ser. No. 11/065,552, while applicable to serial mass storage systems, are most appropriate for mass storage devices with a parallel data bus and a small number of power-supply lines, because for such devices the number of control lines or power lines that need to be switched is less than the number of data lines that would have to be switched to achieve equivalent results.

An alternative approach, disclosed herein, is to connect and disconnect mass storage units, through their data lines, while leaving them enabled, through their control and power lines, at all times. When only data lines are switched, the mass storage units are always fully enabled when the system is in operation, but they can be isolated nevertheless by connecting and disconnecting them through the switching action.

If the relatively new serial ATA mass storage devices are used, for example, it may be more convenient to switch data lines than to switch power lines, because such devices have only four data lines and may have as many as nine power lines. Switching of data lines instead of control or power lines is applicable, however, to a variety of mass storage units and is not limited to serial ATA hard disk drives.

Some serial ATA devices are equipped with the same four-wire power connector used for the earlier EIDE or parallel ATA devices; for such devices, enabling and disabling the devices by switching of control or power lines as disclosed in application Ser. No. 11/065,552 may be preferable to connecting and disconnecting the devices by switching of data lines, because of lower cost.

In another companion patent application Ser. No. 11/140,441, which also is incorporated herein by reference, there is disclosed a system for hardware dual booting by switching the master and slave jumpers or the cable select jumpers on mass storage units provided with such jumpers. The relatively new serial ATA devices have no such jumpers, however, and therefore are not amenable to such an approach.

One purpose of this invention is to provide isolation of one or more mass storage units, such as serial ATA hard disks, for example, from another mass storage unit or group of mass storage units, to ensure privacy of data and programs and to protect against hacking and other harmful or destructive attacks directed at a digital system.

External hard disks have been used to provide increased storage capacity and portability of files. Such hard disks do not, in themselves, provide the isolation made available with this invention, because the external hard disks heretofore available can be independently enabled and thus allow for transfer of data and program code among them and between them and internal hard disks. External hard disks and other external mass storage devices are encompassed by the invention disclosed herein.

A second purpose of this invention is to provide hardware dual booting of mass storage devices by switching of data lines instead of jumpers or control or power lines. Although the techniques disclosed herein are particularly applicable to serial devices, for the reason mentioned above, they are nevertheless applicable to parallel devices as well.

The essence of the invention is the switching of data lines to selected mass storage devices to select which device or devices will be connected at any given time and/or the boot order for a given boot order established by software or firmware. The mass storage units may be serial or parallel devices. All or less than all of the data lines may need to be switched, depending on the design of the mass storage units used.

### BRIEF SUMMARY OF THE INVENTION

The essence of a preferred embodiment of this invention is a system for selecting and connecting one or more of a multiplicity of mass storage units for operation at any given time, while disconnecting one or more others or ensuring that those others are disconnected. That is, those mass storage units that were previously connected, other than any of the newly selected mass storage units that are in that group, are disconnected; and those mass storage units other than the newly selected mass storage units that were previously not connected are prevented from being connected. The selecting and connecting operations are performed by a switching apparatus that comprises selecting or identifying apparatus and connecting apparatus. At any given time each one of the multiplicity of mass storage units has a connected status, which may be either connected or not connected, and that connected status is determined by the switching apparatus.

The selection of one or more of the multiplicity of mass storage units for operation at any given time may be made by hardware or by firmware or software. One of the mass storage units may be a primary mass storage unit, regarded as a part of a computer itself, while the remaining mass storage units collectively are a part of the apparatus disclosed by this invention. Alternatively, all of the mass storage units collectively may be a part of the apparatus disclosed by this invention.

In another form, the invention comprises the selection and connecting apparatus, but not the mass storage units. Again, the connecting apparatus is capable of connecting one or more of a multiplicity of mass storage units for operation at any given time, while disconnecting one or more others or ensuring that those others are not connected, provided that the mass storage units are added.

In some embodiments, only one mass storage unit is connected; the other mass storage units in the system are disconnected or not connected. Consequently, it is not possible to exchange files among the various mass storage units, and each mass storage unit defines a distinct digital computer, on the basis of the programs and data stored within it. In effect, multiple digital computers are made available within what appears to be a single digital computer, by the selection of the mass storage unit to be used. Each mass storage unit may employ a distinct operating system, or the same operating system may be used on two or more of the mass storage units.

This invention encompasses all types of mass storage units, regardless of the kind of interface with the rest of the computer, and all kinds of digital systems, special-purpose systems as well as general-purpose digital computers. The interface may be IDE, EIDE, parallel ATA, serial ATA, SCSI, serial port, parallel port, USB, Firewire, wireless, optical, or any other kind. The digital system may be a mainframe, a personal computer (IBM, IBM-compatible, or Macintosh, for example), or any other kind, including a reservation system, a multifunction telephone, a multifunction DVD player, and a multifunction television receiver, among others.

A more complex system that falls also within the scope of this invention is a system comprising more than two mass storage units, in which any selected combination of those mass storage units can be connected and the remaining mass storage units disconnected or not connected.

As an example of a simple embodiment, a digital computer can be provided with multiple hard disks. A particular one of the multiple hard disks can be selected and placed in a connected state by a switching system that may be mechanical, optical, electrical, software, firmware, or some combination thereof; the other hard disks are maintained in a disconnected state by the switching system. Each disk can be assigned to a different user, if desired. Thus, it is possible to operate one “computer” offline at times to maintain privacy of data files from a connected network or alternatively operate each of the other “computers” in the network at other times to allow exchange of information with remote computers via the network, for example.

Then, if the switching system is so constructed that a change in the selection of the connected disk can be achieved only by use of a distinct key or code for one or more selections, one or more users can maintain their files in complete privacy from the users of the other “computers” in the group. The locking device in which the key or code is used may be hardware, software, firmware, or a combination thereof, or a mechanical lock may be used. A keyswitch is a particularly simple device for providing such security. The lock may be contained within the housing of the digital system, it may be located on the exterior of that housing, or it may be mounted at the end of a cable connected to the switching circuit, for example.

In addition to maintaining privacy of all files on one or more of the “computers” in the group from other “computers” in the group, this system allows a single user to operate two of the “computers”, one having access to a connected network and the other not. Thus, this system protects the “computer” not connected to the network from viruses, worms, and all other forms of harmful intrusion transmitted over the network while still allowing uninhibited use of the network on the other “computer”. If disaster strikes, in the form of a virus attack, for example, all of the files on the private “computer” are unaffected. Software on the hard disk that defines the public “computer” can be restored without endangering the private files on the other hard disk, and operation can be resumed with minimal trauma. Only the programs and other files to be used on the network will be kept on the public disk, so only they will need to be restored after disaster strikes. If only a minimal set of programs and other files are stored on the public disk, the effort required to recover from the disaster is minimized.

Even if antivirus software is used, viruses and other harmful pieces of code can infect a computer, because the user has not kept the antivirus software up to date or simply because protection against a new piece of infectious code has not yet been incorporated into the antivirus software by the supplier. Therefore, the use of an isolated disk system can be of benefit to even those users who employ protective software.

The same protection can be achieved, of course, by physically removing one hard disk and replacing it with another. Such a process is cumbersome and time consuming, however. Moreover, it introduces the possibility of causing substantial damage to the computer.

The use of two completely independent conventional computers will provide the same protection against data corruption, but this invention provides the desired capability at a very substantially reduced cost in terms of weight, volume, and dollars.

A minor modification of this invention is the incorporation of the switch in the system disclosed herein into the power switch of the computer so that the power switch has multiple positions: off, on with the first of two hard disk drives connected and the second drive disconnected, and on with the second of the hard disk drives connected and the first drive disconnected, for example.

Although only one of the mass storage units can be connected at any given time in the preferred embodiment, in other embodiments there is no such restriction. In some such embodiments, a single mass storage unit or other proper subset of the totality of mass storage units in the system is connected when power is made available, as described above; but after the boot disk has been selected by the host computer, hardware and/or firmware or software can be used to connect one or more other mass storage units, so that data can be exchanged freely among the various units.

Also disclosed by this invention is a selectable mass memory system comprising a group of mass storage units for use with a separate mass storage unit that is a part of another digital system, a switching apparatus for selecting one of the totality of mass storage units, and a connecting apparatus for connecting the selected mass storage unit and ensuring that the other mass storage units are not connected. The separate mass storage unit may, for example, be the original hard disk in a digital computer, while the selectable mass storage system is an add-on system or upgrade to the digital computer.

To facilitate installation of the switching and connecting system disclosed in this invention in a personal computer, the switching and connecting system can be provided with one or more connectors appropriate for mating with standard connectors provided within a personal computer.

This invention comprises also a hardware multiple boot system, which is more convenient to install and more convenient to operate than existing software multiple boot systems.

The use of dual booting in a digital computer is not new. Software dual booting of digital computers has been employed to permit selection of a particular hard disk or partition from which to boot an operating system in computers in which operating systems have been installed on multiple hard disks and/or partitions. The selection of the hard disk or partition to be booted has been made heretofore by software means, however, and the process of applying software to enable dual booting has had the potential to damage or destroy files stored on the hard disk(s) installed in the computer. Moreover, there are many restrictions on file systems (e.g., FAT, NTFS, FAT32) that may be used in software-controlled dual-boot systems, as described in the topic Installing Multiple Operating Systems in the Microsoft 2000 Professional Help window. In some cases, even if the restrictions are observed, files in one file system (e.g., NTFS) are not available when an operating system based on another file system (e.g., Windows98) is in use. Under the topic Installing Multiple Operating Systems in the Microsoft 2000 Professional Help window it is stated that if one wants to install Windows NT 4.0 or Windows 2000 with Windows 95 or Windows 98, the boot volume must be formatted as FAT, not NTFS and that Windows 95 OSR2, Windows 98, and Windows 2000 will support FAT32 volumes.

It is stated also that, if one formats a Windows NT 4.0 or Windows 2000 volume with any file system other than NTFS, one will lose all NTFS-specific features, including in Windows 2000 some security features, encrypting file system (EFS) settings, disk quotas, and Remote Storage. Additionally, it is stated that Windows 95 and Windows 98 cannot recognize an NTFS partition and will identify it as unknown. The user is cautioned, therefore, that if he formats a Windows 98 partition as FAT and a Windows 2000 partition as NTFS any files on the NTFS partition will be unavailable if he tries to access them while running Windows 98.

Another disadvantage of a software-controlled dual-boot system is that each operating system is treated as a separate entity. In a software dual-boot system each operating system has access only to those programs and data stored on the same hard disk or partition as the operating system itself If it is desired to be able to execute a given program or access a given data file from each of two different operating systems, the program or data file stored on the hard disk or partition containing one of the two operating systems must be replicated on the hard disk or partition containing the other operating system. This limitation also is described under the topic Installing Multiple Operating Systems in the Microsoft 2000 Professional Help window, where the user is warned that any programs and drivers he wants to use must be installed under each operating system. He is advised that, for example, if he wants to use Microsoft Word on the same computer under both Windows 98 and Windows 2000, he must start Windows 98 and install Microsoft Word and that then he must restart his computer under Windows 2000 and install Microsoft Word again.

Furthermore, establishing software-controlled dual booting is a very time-consuming and complex process, beyond the capability of many users of personal computers. Even those who are capable of establishing a software dual-boot system find the setup process tedious and unpleasant. Moreover, the software is subject to crashes and the need to repeat the setup process, possibly many times.

One of the purposes of this invention is to provide a system for dual booting of a computer system that is simpler to install than the software systems heretofore used and the installing of which does not have the potential for damaging or destroying files stored on the computer that is present in the heretofore used procedures for installing those software dual booting systems. A further purpose of this invention is to eliminate the restrictions on the types of file systems that may be used, so that each operating system can utilize any file system with which it is compatible, without regard to the file system requirements of another operating system to be used on the same computer. Still another purpose of this invention is to permit each operating system to execute all programs compatible with that operating system regardless of whether those programs are stored on the same hard disk as the operating system or on another hard disk. An additional purpose is to provide a dual-boot system that is impervious to software crashes in the installation process.

Furthermore, the hardware dual-booting apparatus disclosed herein can be used with mass storage units that are not compatible with the hardware dual-booting apparatus disclosed in patent application Ser. No. 11/140,441. For example, serial ATA hard disk drives cannot be jumpered for use as either a master or a slave, nor can they be jumpered for cable select operation. In effect, all serial ATA hard disks are masters.

Nevertheless, they can be used in a dual-boot configuration through use of the selecting and connecting apparatus disclosed herein. A serial ATA hard disk, for example, has four data lines, whereas the comparable parallel ATA device has eight In a multi-disk system using serial ATA hard disks, the disk from which the computer boots is determined by the port to which the disk is connected. The boot order of the ports is determined by firmware or software. In one embodiment of this invention, the data lines of serial ATA hard disks are switched to different ports to change a disk operating as a master to the role of a slave and to change to master status a disk that had appeared to be a slave.

Similar results can be achieved with parallel ATA hard disks by switching one or more control lines, as disclosed in companion patent application Ser. No. 11/140,441.

Although this invention encompasses the switching of data lines on parallel devices as well as on serial devices, the technique is particularly advantageous in application to serial devices because of their relatively small number of data lines. In some cases only one data line per device need be switched; in other cases all data lines must be switched. The number of data lines in each case is less for a serial device than for a comparable parallel device, however.

Hard disk drives are used today for mass storage, but they may be replaced in the future by flash memory or EEPROM, for example, or by other kinds of mass memory unit. Even CD-RW drives, DVD-RW drives, and DVD+RW drives may be used for mass storage units. This invention encompasses the hard disk drives used today and all successors to those drives as mass storage units in digital systems.

It is an object of this invention to make connecting/disconnecting the data lines on the mass storage units a simple matter, so that each time power is applied to the computer the computer can be booted from any desired disk. This objective is realized by providing a switching apparatus that can easily be actuated by the computer user, preferably from outside the computer. As a result, the user can easily reconfigure each hard disk drive in the computer as an apparent master, as an apparent slave, or as neither, as desired, from time to time. The conductors may be permanently attached to the pins on the mass storage unit, or they may be removably connected by use of connectors. Furthermore, a different design of hard disk drive may be used, in which no connector pins are provided, but conductors are brought out from the interior of the drive for connection to a switching apparatus.

Regardless of the type of mass storage unit used, the selection of each of the hard disk drives to serve as master, slave, or neither at any given time may be made by hardware (e.g., mechanical, electrical, or optical apparatus), firmware, software, or some combination thereof. Typically, the switching apparatus comprises a manually operated switch, but the switch may be optically actuated by a remote control device, for example. The switch may be mounted within the housing of the host digital system, on the exterior of the host digital system, or at the end of a cable connected to the remainder of the switching circuit, for example.

One of the hard disk drives may be a primary drive, regarded as a part of a computer itself, while the remaining hard disk drive(s) are a part of the apparatus disclosed by this invention. Alternatively, all of the hard disk drives may be a part of the apparatus disclosed by this invention.

In another form, the invention comprises the switching apparatus, but not the hard disk drives. Again, the switching apparatus is capable of establishing each hard disk drive as apparent master, slave, or neither, provided that the hard disk drives are added.

Each hard disk drive may employ a distinct operating system, or the same operating system may be used on multiple hard disk drives.

Thus, this invention discloses also a hardware dual boot system, which is more convenient to install and more convenient to operate than existing software dual boot systems. Moreover, this hardware dual boot system provides the user of an operating system on a first hard disk with access to those files on a second hard disk that are compatible with the operating system being used on the first hard disk.

This invention encompasses all types of hard disk drives, and all successors thereto, regardless of the kind of interface with the rest of the computer, and all kinds of digital systems, special-purpose systems as well as general-purpose digital computers. The interface may be IDE, EIDE, SCSI, serial port, parallel port, parallel ATA, serial ATA, USB, Firewire, wireless, optical, or any other kind. The digital system may be a mainframe, a personal computer (IBM, IBM-compatible, or Macintosh, for example), or any other kind, including a reservation system, a multifunction DVD player, a multifunction television receiver, and a multifunction telephone, among others, provided that the computer is capable of recognizing the hard disk drives.

In other embodiments, after one hard disk drive has been established in the role of master and a second drive has been established in the role of slave, the roles of the two drives can be reversed by switching controlled by hardware, firmware, or software. This can be done, for example, by modifying the computer's BIOS and/or its configuration file, or by actuating a mechanical switch.

If the switching system is so constructed that a change of the hard disk drive selected or of the master/slave status of the hard disk drives can be achieved only by use of a distinct key or code for each selection, then each disk can be assigned to a different user or group of users, and each user or group of users can be provided with an operating system that is not available to the user(s) of the operating system on the other hard disk drive. The locking device in which the key or code is used may be hardware, software, firmware, or a combination thereof, or it may be a mechanical lock. A keyswitch is a particularly simple device for providing such privacy.

Also disclosed by this invention is a switchable master/slave system comprising one hard disk drive for use with a separate hard disk drive that is a part of another digital system. The separate hard disk drive may, for example, be the original hard disk drive in a digital computer, whereas the switchable master/slave system including the separate hard disk drive is an add-on system or upgrade to the digital computer.

Yet another embodiment of this invention is switching apparatus that does not include a hard disk drive but is capable of establishing one hard disk drive in the role of master and a second hard disk drive in the role of slave, if the hard disk drives are added. Such switching apparatus may also be an add-on system or upgrade to a digital system.

To facilitate installation of the switching apparatus disclosed in this invention in a personal computer, the switching apparatus can be provided with one or more connectors appropriate for mating with standard connectors provided within a personal computer and/or standard connectors provided on a hard disk drive. Alternatively, the switching apparatus may be hard-wired to the digital computer and/or to one or both of the hard disk drives.

A minor modification of this invention is the incorporation of the switch in the switching system into the power switch of the computer so that the power switch has multiple positions: off, on with the first of two hard disk drives serving as master and the second drive serving as slave, and on with the second of the hard disk drives serving as master and the first drive serving as slave, for example. If there are more than two hard disk drives in the system, the number of positions on such a switch can be greater than three, of course.

The above and other advantages and features of the invention will be apparent to those skilled in the art from the following descriptions of particular embodiments taken in conjunction with the accompanying drawings.

### BRIEF DESCRIPTION OF THE DRAWINGS

FIG. 1 is a block diagram that defines a selectable mass storage system as disclosed herein.

FIG. 2 illustrates one embodiment of this invention, in which solid-state switching of two hard disks is utilized, with protection against inadvertent switching of the disks while power is applied.

FIG. 3 illustrates an embodiment of this invention in which the number of disks from which selection can be made is greater than two, with protection against inadvertent switching of disks while power is applied.

FIG. 4 is a broad illustration of control apparatus for performing the connecting and disconnecting of mass storage units disclosed herein.

FIG. 5 illustrates one embodiment of a controller for a switchable master-slave system utilizing serial ATA hard disk drives.

### DETAILED DESCRIPTION OF THE INVENTION

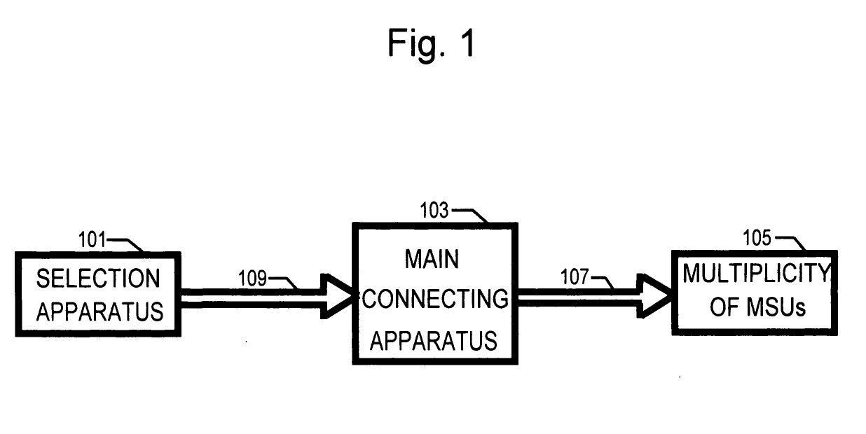

The block diagram in FIG. 1 depicts in a very general way a selectable mass storage system encompassed by this invention. A multiplicity of mass storage units (MSUs) 105 is connected via a first connecting apparatus 107 to main connecting apparatus 103 capable of connecting one or more of the multiplicity of MSUs 105 to a primary digital system and disconnecting the remainder of the multiplicity of MSUs 105 from the primary digital system or ensuring that they are not connected thereto. The primary digital system is not illustrated in FIG. 1 because it is not a part of this invention; it is, however, understood to be connected to the main connecting apparatus 103, which performs the task of connecting and disconnecting members of the multiplicity of MSUs 105 to and from it. For simplicity of expression, terms such as “disconnecting the remainder of” and “disconnect the remainder of” are used hereafter to include “ensuring that they are not connected” and “ensure that they are not connected”, respectively, unless the context clearly implies otherwise. Also for simplicity of expression, terms such as “connecting one or more of” or “connect one or more of” are sometimes used hereafter to include disconnecting other units, unless the context clearly implies otherwise. In addition, the term “computer” includes both general-purpose computers and special-purpose computers, such as reservation systems, multi-purpose telephones, multi-purpose DVD players, multi-purpose television receivers, and others.

The particular mass storage units in the multiplicity of MSUs 105 to be connected are identified by signals provided via a second connecting apparatus 109 to the main connecting apparatus 103 by identification or selection apparatus 101. Each of the first connecting apparatus 107 and the second connecting apparatus 109 may contain a connector to facilitate connection. The multiplicity of mass storage units 105, the first connecting apparatus 107, the main connecting apparatus 103, the second connecting apparatus 109, and the identification or selection apparatus 101 may be parts of a digital computer, having been installed therein when the digital computer was constructed. In some embodiments of this invention, the second connecting apparatus 109 is absent, because the selection apparatus 101 and the main connecting apparatus 103 are the same or are integrated into a combined switching apparatus.

Also encompassed by this invention is a kit comprising the identification or selection apparatus 101, the second connecting apparatus 109, the main connecting apparatus 103, the first connecting apparatus 107, and one or more mass storage units exclusive of a mass storage unit, regarded as a primary mass storage unit, contained within an existing digital computer to which the kit is intended to be added. Such a kit may be regarded as an upgrade for a digital computer.

Another structure encompassed by this invention comprises the identification or selection apparatus 101, the second connecting apparatus 109, the main connecting apparatus 103, and the first connecting apparatus 107, but no mass storage unit. Such a structure may also take the form of a kit for upgrading a digital computer, but it may be used with a multiplicity of mass storage units 105, regardless of whether the multiplicity of mass storage units 105 is contained within a digital computer.

The lines that are connected and/or disconnected are data lines used for either parallel or serial data transmission. The mass storage units encompassed by this invention may be but need not be associated with a general-purpose digital computer. The switching of the data lines can be accomplished by one or more mechanical switches, one or more electromechanical relays, electronic tristate drivers, electronic multiplexers, other forms of electronic switches, or other means known to those skilled in the art.

This invention encompasses all forms of MSU, including external devices that may be connected to the computer by serial port, parallel port, universal serial bus, Firewire, serial ATA, and any other form of information transfer apparatus. Also encompassed are multiport controllers, which are not limited to a single MSU but can interface groups of MSUs to a host.

One embodiment of a switched mass storage system, presented here as one example of this invention, comprises two internal hard disk drives in an IBM PC or an IBM-compatible PC with serial ATA interface, for example. In this example, the computer originally contained a single serial ATA hard disk drive. A switched mass storage system is added, to form an isolated disk system. The added switched mass storage system includes a switching assembly comprising a first connector that mates with the connector on the cable provided in the computer for connecting data lines to a serial ATA hard disk drive; a second connector and a third connector, each identical to the host serial ATA connectors provided in the computer; and a switching circuit. The switching circuit assembly is contained in the main connecting apparatus 103 and typically takes the form of a printed-circuit board mounted on a metal bracket that can be substituted for a cover on one of the slots on the back of the computer, with a switch mounted on the bracket so that it can be actuated from outside the computer. Also provided are an additional serial ATA hard disk drive and two serial ATA cable assemblies. Variations in the contents of the switching circuit assembly may be found in other embodiments of this invention, however.

The two host transmit lines and the two host receive lines emerging from the first connector are connected as inputs to the switching circuit. The outputs of the switching circuit include a host transmit + wire, a host transmit − wire, a host receive + wire, and a host receive − wire connected to the appropriate pins in the second connector in the assembly; and a host transmit + wire, a host transmit − wire, a host receive + wire, and a host receive − wire connected to the appropriate pins in the third connector in the assembly. The ground pins in the first connector are connected to the ground pins in the second connector and the third connector, either directly or through the switching circuit. The switching circuit may comprise the selection apparatus 101 and the second connecting apparatus 109. Alternatively, the selection apparatus 101 may comprise an infra-red, r-f, or ultrasonic remote signaling device, for example, with an electrical cable or a path through the air, for example, serving as the second connecting apparatus 109. The switching action is such that in a first state of the switching circuit the two host transmit lines and the two host receive lines that serve as inputs to the switching circuit are connected to the corresponding pins in the second connector but not to pins on the third connector. In a second state of the switching circuit the two host transmit lines and the two host receive lines at the input to the switching circuit are connected to the corresponding pins on the third connector but not to pins on the second connector.

Prior to installation of the isolated disk assembly in the computer, the serial ATA hard disk to be added to the computer is formatted in the usual way, and the desired operating system is installed on it.

Installation of the isolated disk system in the computer consists of a) disconnecting the serial ATA hard disk drive in the computer from the serial ATA cable assembly to which it was connected; b) physically installing in the computer the serial ATA hard disk drive to be added; c) connecting the added hard disk drive to either the second connector or the third connector in the switching circuit, using one of the two serial ATA cable assemblies provided; d) connecting the original hard disk drive in the computer to the other of the second connector and the third connector in the switching circuit, using the second of the serial ATA cable assemblies provided; e) physically installing the switching circuit assembly in the computer; and f) connecting the first connector in the switching circuit to one of the host serial ATA connectors provided in the computer, using the serial ATA cable assembly provided in the computer.

Thereafter, either of the two serial ATA hard disks can be selected by appropriate actuation of the switch in the switching circuit assembly prior to turning on the computer, and the computer will function normally with the selected hard disk serving as the mass storage unit of the computer.

A minor modification of this embodiment is the incorporation of the switch of the isolated disk system in the power switch of the computer so that the power switch has multiple positions: off, on with only the first of the hard disk drives active, and on with only the second of the hard disk drives active.

If desired, after the computer has been booted with the master drive, the second hard disk drive can be connected to another port on the host computer with a modified form of the switching circuit, so that both hard disk drives can be operated concurrently, under the control of software on the boot disk, in systems in which operation with two operating systems installed is permitted. Thus, the boot disk serves as a master, and the other disk serves as a slave. This would not be done, of course, in a system in which disk isolation is desired.

A very simple form of switching circuit for an exemplar isolated drive system utilizing serial ATA hard disk drives comprises a four-pole, double-throw switch. One of the rotors of the switch is connected to the host transmit + line at the input to the switching circuit, one rotor is connected to the host transmit − line at the input to the switching circuit, a third rotor is connected to the host receive + line at the input to the switching circuit, and the fourth rotor is connected to the host receive − line at the input to the switching circuit. In a first position of the rotors, the stator terminals in contact with the rotors are connected to the corresponding terminals on the second connector in the switching circuit; and in a second position of the rotors, the stator terminals in contact with the rotors are connected to the corresponding terminals on the third connector in the switching circuit. In this way, the connected state of the first serial ATA hard disk drive and the connected state of the second serial ATA hard disk drive are determined by the switching apparatus.

Simplicity and economy are advantages of this kind of switching apparatus; the selection apparatus 101 is the handle of the switch, the main connecting apparatus 103 comprises the electrical contacts on the switch, and the second connecting apparatus 109 comprises the linking apparatus that converts the mechanical motion of the switch handle to the electrical switching of the contacts. An alternative viewpoint is that the selection apparatus 101 and the second connecting apparatus 109 have been absorbed into the main connecting apparatus 103, with the switch serving as both the selection apparatus 101 and the switching circuit.

A disadvantage of this kind of switching circuit is that the switch can be actuated inadvertently while the computer is in operation, which can result in loss of data and malfunction of the software. A small improvement can be effected by recessing the switch so that inadvertent actuation is less likely or by use of a rotary switch with a round knob, for example, instead of a toggle switch. A better improved embodiment inhibits switching except at the time the computer is booted. Such inhibition of switching can be achieved by inhibiting changes in the identification or selection of mass storage unit to be connected except at the time the computer is booted or by inhibiting changes in the connecting/disconnecting of mass storage units except at the time the computer is booted, regardless of whether changes in identification or selection have been made.

One preferred embodiment of this invention that incorporates such inhibition of switching comprises a resistor-capacitor charging circuit similar to those used in power-on reset circuits, a single-pole, single-throw switch, and a relay with a holding contact. The rotor contact of the switch is connected to the junction of the resistor and the capacitor. The other terminal of the capacitor is connected to an appropriate output terminal of the power supply, and the other terminal of the resistor is connected to ground. When the computer is turned on, the power supply output voltage is connected for only a short interval of time (the power-on delay time) to the rotor contact of the single-pole, single-throw switch through the capacitor, as it charges. The stator terminal of the switch is connected to one terminal of the relay coil; the other terminal of the relay coil is grounded. The relay has five sets of double-throw contacts (i.e., form C). Four of the five sets of contacts are connected as the stator terminals on the double-pole, double-throw switch in the previous example. The fifth rotor contact and the normally open stator contact associated with it are used as a holding circuit, to maintain the power supply voltage on the relay coil after the capacitor has charged if the relay has been actuated.

If the switch was open, and hence a first disk drive was selected, at the time of booting of the computer, the relay is not actuated at boot-up; and it cannot be actuated after the power-on delay time has expired because the voltage applied to the rotor of the single-pole, single-throw switch is then zero. Therefore, the selection of disk drive to be used cannot be changed later in that event.

If the switch was closed, and hence the second disk drive was selected, at the time the computer was booted, the relay is actuated at boot-up. The holding contacts then serve to maintain the connection from the power supply to the relay coil after the power-on delay time has expired. Because of the action of the holding circuit, the selection of disk drive to be used cannot be changed later by changing the state of the switch in that event, either.

Thus, changes in the enabled state of the mass storage units are inhibited except at the time the computer is booted.

A single-pole, double-throw switch may be used instead of the single-pole, single-throw switch, if desired, with the resistor connected to the stator terminal not connected to the relay coil instead of to the capacitor. Because relays with five sets of form C contacts are not widely available commercially, two relays may be used instead of one.

One alternative is to use a silicon-controlled rectifier (SCR) in series with the relay coil, with the gate of the SCR driven, through an appropriate resistor, from the stator of the single-pole, single-throw switch. Then the relay need have only four sets of form C contacts, since the holding action is performed by the SCR. Such relays are readily available commercially.

Another alternative is to use the switch to set or reset a flip-flop that applies power to the relay coil in one state but not in its other state. After the power-on time delay, the state of the flip-flop cannot be changed and hence the connected states of the two hard disk drives cannot be changed.

Other means of inhibiting changes in the selected and connected hard disk drive except at the time power is applied to the computer will be known, as well, to those skilled in the art.

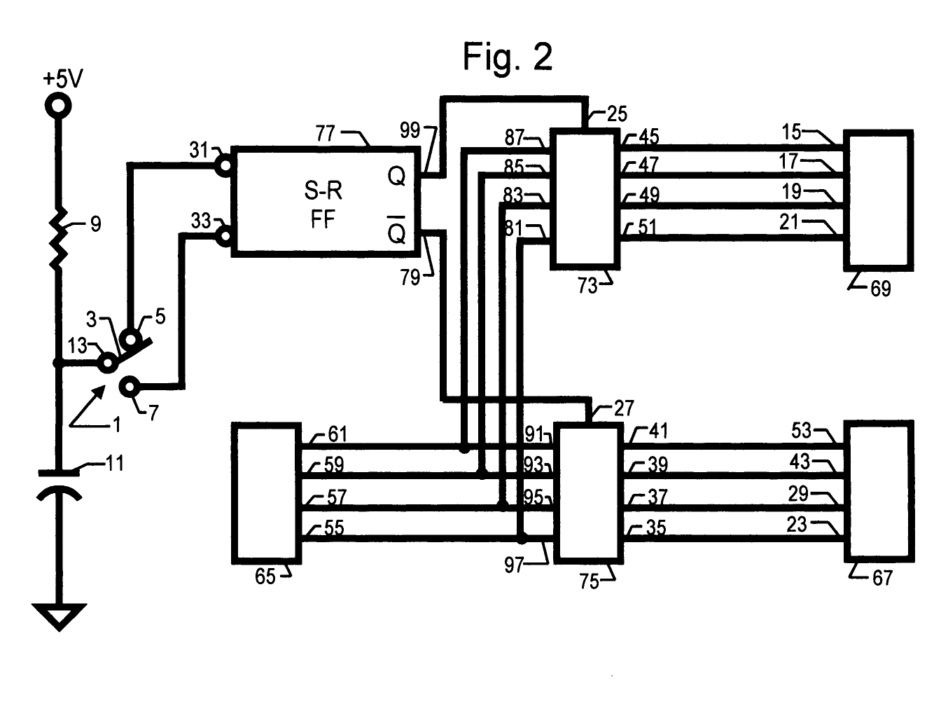

In another, preferred, embodiment the relay of the preceding example is replaced by a solid-state circuit. Such an embodiment is illustrated in the following example, with reference to FIG. 2.

The S-R flip-flop 77 may be an integrated circuit or part of an integrated circuit, or it may be constructed from NAND gates or NOR gates, for example. A first connector 65 is intended for connection by means of an appropriate cable to an appropriate serial ATA port in a host computer. Pins 55, 57, 59, and 61 in the first connector 65 are connected to input pins 81, 83, 85, and 87 on a first switching device 73 and to input pins 97, 95, 93, and 91 on a second switching device 75. Each switching device may comprise field effect transistors, a muiltichannel analog gate, or other controllable electronic analog transmission means, for example. It may be an electromechanical relay with four form A contacts. In still another alternative design, the first switching device 73 and the second switching device 75 may be combined in a single electromechanical relay with four form C contacts, with its coil receiving excitation from one of the outputs 79 and 99 of the flip-flop 77 and the other output of the flip-flop 77 not used.

A second connector 69 and a third connector 67 are intended for connection by means of appropriate cables to two serial ATA hard disk drives. The output pins 45, 47, 49, and 51 of the first switching device 73 are connected to the corresponding pins 15, 17, 19, and 21 of the second connector 69; and the output pins 35, 37, 39, and 41 of the second switching device 75 are connected to the corresponding pins 23, 29, 43, and 53 of the third connector 67. The two switching devices 73 and 75 serve to connect pins 55, 57, 59, and 61 in the first connector 65 to the corresponding pins 21, 19, 17, and 15 in the second connector 69 in a first state and to the corresponding pins 23, 29, 43, and 53 in the third connector 67 in a second state. The ground connections in the data bus of the second connector 69 and in the data bus of the third connector 67 are permanently connected to the corresponding pins in the first connector 65, as explained previously.

At the instant that power is applied to the circuit, a capacitor 11 begins to charge through a resistor 9 and the input circuit of the first flip-flop 77, providing a transient logic zero voltage at the rotor terminal 13 of a switch 1. If at that time the rotor blade 3 of the switch 1 is in contact with a first stator terminal 7 of the switch 1, then the logic zero voltage is applied to the first input terminal 33 of the flip-flop 77, while no input voltage is applied to the second input terminal 31 of the flip-flop 77. As a result, the flip-flop 77 is forced into its logic 0 state, with a logic 0 at its Q output terminal 99 and a logic 1 at its complementary output terminal 79.

The logic 1 voltage at the complementary output terminal 79 of the flip-flop 77 is applied to a control input terminal 27 on the second switching device 75. As a result, the second switching device 75 enters its second state, in which its input terminals 91, 93, 95, and 97 are connected to its output terminals 41, 39, 37, and 35, respectively. The logic 0 voltage at the Q output terminal 99 of the flip-flop 77 is applied to a control input terminal 25 on the first switching device 73. As a result, the first switching device 73 remains in its first state, in which its input terminals 81, 83, 85, and 87 are disconnected from its output terminals 51, 49, 47, and 45. Consequently, the first connector 65 is connected to the third connector 67 and a serial ATA hard disk drive connected to the third connector 67 is connected via the first connector 65 and a cable assembly in the host computer to a serial ATA port in the host computer; and a serial ATA hard disk drive connected to the second connector 69 is not connected to the host computer.

If at the instant that power is applied to the circuit the rotor blade 3 is in contact with a second stator terminal 5 of the switch 1, then the logic zero voltage is applied to the second input terminal 31 of the flip-flop 77, while no input voltage is applied to the first input terminal 33 of the flip-flop 77. Then the flip-flop 77 is forced into its logic 1 state, with a logic 1 voltage at its Q output terminal 99 and a logic 0 voltage at its complementary output terminal 79. As a result, the first switching device 73 enters its second state, in which its input terminals 81, 83, 85, and 87 are connected to its output terminals 51, 49, 47, and 45, respectively. As a result of the logic 0 voltage applied to the control input terminal 27 of the second switching device 75 the second switching device 75 remains in its first state, in which its input terminals 91, 93, 95, and 97 are not connected to its output terminals 41, 39, 37, and 35. Consequently, the second connector 69 is connected to the first connector 65, and a serial ATA hard disk drive connected to the second connector 69 is connected via the first connector 65 and a cable assembly in the host computer to a serial ATA port in the host computer; and a serial hard disk drive connected to the third connector 67 is disconnected from the host computer.

After the capacitor 11 has charged, the voltage on the rotor terminal 13 of the switch 1, and hence the voltage on whichever of the stator terminals 5 and 7 is in contact with the rotor blade 3, is a logic 1 voltage. If the state of the switch 1 is changed after the capacitor 11 has charged, therefore, the flip-flop 77 does not respond, because its inputs are both logic 1. That is, the flip-flop 77 memorizes the state of the switch 1 at the instant that power is applied to the circuit, and changing the state of the switch 1 thereafter has no effect on the connecting/disconnecting of the second connector 69 and the third connector 67 to the first connector 65. Thus, changes in the connected state of the mass storage units connected to the second connector 69 and the third connector 67 are inhibited except during a short interval of time immediately after power is made available to the switching circuit.

Although the above description of a preferred embodiment of this invention does not include mass storage units, in other embodiments a switching system, one version of which comprises the components shown in FIG. 2, may be provided together with one or both of the mass storage units.

Optionally, the switching system may be designed so that the hard disk drives are connected to different ports on the computer instead of to the same port.

In some embodiments the switching circuit is simplified by switching only one of the transmit lines and/or one of the receive lines, with the unswitched lines permanently connected, instead of switching both transmit lines and both receive lines.

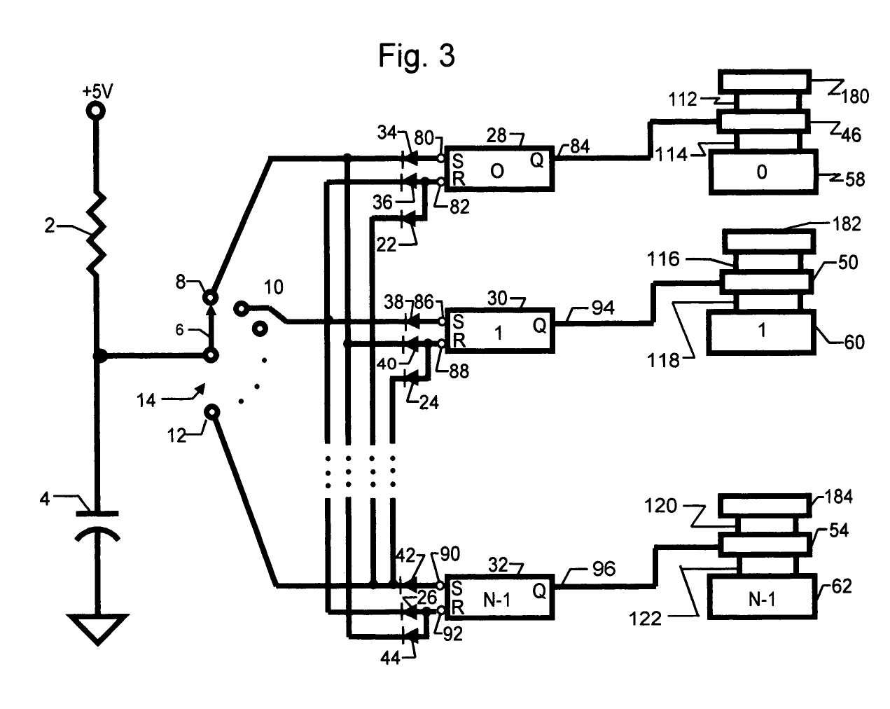

As another example of this invention, a switched disk system comprising more than two disk drives is illustrated in FIG. 3. The total number of disk drives is N; the drives are identified as drive 0 58, drive 1 60, . . . , and drive N-1 62.

Drive 0 58 is shown to be connected to a switch 0 46 via switch 0 input conductors 114 and connectable to port 0 180 through switch 0 46 via switch 0 output conductors 112. Similarly, drives 1 60, . . . , N-1 62 are shown to be connected to switch 1 50, . . . , and switch N-1 54, respectively, via switch 1 input conductors 118, . . . , and switch N-1 input conductors 122 and connectable to ports 1 182, . . . , N-1 184, respectively, through switch 1 50, . . . , and switch N-1 54, respectively, via switch 1 output conductors 116, . . . , and switch N-1 output conductors 120, respectively. Each of the flip-flops 28, 30, . . . , 32 may be similar to the flip-flop 77 in FIG. 2 Each of the switches 46, 50, . . . , 54 may be similar to the first switching device 73 in FIG. 2. If the number of data lines per hard disk drive to be switched is greater than four, multiple relays can be used in each of the switches 46, 50, . . . , 54. Alternatively, the switching circuit may take any other form, and utilize any other components, that will allow connecting one of the hard disk drives 58, 60, . . . , 62 to and disconnecting it from the host port.

Just as switch 0 46 is actuated by the Q output 84 of flip-flop 0 28, switch 1 50 is actuated by the Q output 94 of flip-flop 1 30, . . . , and switch N-1 54 is actuated by the Q output 96 of flip-flop N-1 32.

Although each of the hard disk drives 58, 60, . . . , 62 is shown connected to a distinct port for generality, they may all be connected to the same port, if desired, or to some other subset of the N ports 180, 182, . . . , 184 shown. That is, because only one of the mass storage units 58, 60, . . . , 62 is connected at any given time, all of the ports 180, 182, . . . , 184, or any subset of them, may be the same port.

Each drive is connected by providing a logic 1 at the Q output of the flip-flop associated with that drive, and disconnected by providing a logic 0 at the output of the same flip-flop.

Flip-flop 0 28 will provide a logic 1 signal at its Q output terminal 84 when a logic 0 signal is applied at its set input terminal 80 with no signal applied to its reset input terminal 82 and will retain the logic 1 signal at its Q output terminal 84 thereafter until a logic 0 signal is applied at its reset input terminal 82 with no signal applied to its set input terminal 80. The signal at the Q output 84 of flip-flop 0 28 then changes to a logic 0 signal. After the logic 0 signal appears at the Q output terminal 84 of flip-flop 0 28, flip-flop 0 28 will retain the logic 0 signal at its Q output terminal 84 until a logic 0 signal is applied at its set input terminal 80 with no signal applied to its reset input terminal 82. Flip-flops 1 30, . . . , N-1 32 operate in the same manner as flip-flop 0 28.

A logic 0 signal is applied to flip-flop 0 28 at the set input terminal 80 via a diode 34 during the time interval in which the voltage on the charging capacitor 4 is low if the rotor blade 6 of the selector switch 14 is in contact with a first stator terminal 8 of the selector switch 14 during that interval. When a logic 0 signal is applied to flip-flop 0 28 at the set input terminal 80, that logic 0 signal is applied also to flip-flop 1 30, . . . , and flip-flop N-1 32 at their reset input terminals 88, . . . , 92, via isolating diodes 40, . . . , 44. The isolating diodes 34, 36, 22, 38, 40, 24, . . . , 42, 26, and 44 are required to prevent logic 0 signals applied to one flip-flop from affecting other flip-flops.

Similarly, a logic 0 signal can be applied via a diode 38 to flip-flop 1 30 at its set input terminal 86 and via isolating diodes 36, . . . , and 26 to all of the other flip-flops at their reset input terminals 82, . . . , and 92, if the rotor blade 6 of the selector switch 14 is in contact with a second terminal 10 of the selector switch 14. In the same way, a logic 0 signal can be applied via a diode 42 to flip-flop N-1 32 at its set input terminal 90 and via isolating diodes 22, 24, . . . to all of the other flip-flops 28, 30, . . . at their reset input terminals 82, 88, . . . , if the rotor blade 6 of the selector switch 14 is in contact with the Nth stator terminal 12 of the selector switch 14.

Thus, by putting the rotor blade 6 of the selector switch 14 in contact with the appropriate stator terminal 8, 10, . . . , or 12 before power is applied to the switching circuit, it is possible to connect any one of the hard disk drives 58, 60, . . . , 62 and disconnect all of the remaining hard disk drives for as long as power is present.

Because the capacitor 4 charges through a resistor 2 and the set input circuitry of the selected flip-flop in series with a diode, the voltage on the capacitor 4, and hence the logic signal applied to the rotor blade 6 of the selector switch 14, remains low for only a brief time after power is applied to the switching circuit; therefore, the selection of the hard disk drive to be enabled cannot be changed until after power has been removed from the switching circuit.

In another version of this embodiment of the invention, provision is made also for the selection and connection of any desired distinct combination formed from the N hard disk drives. This can be accomplished, for example, by modifying the system illustrated in FIG. 3 as follows. For each desired distinct combination of hard disk drives in FIG. 3, an additional stator terminal is added to the selector switch 14; then the cathodes of N additional diodes are connected to that stator terminal, and a connection is made from the anode of each of those diodes to the set input terminal of the flip-flop associated with a distinct drive in the combination to be selected and to the reset input of the flip-flop associated with a distinct one of all other drives. If there are to be M hard disk drives in the combination to be selected, there will be connections through diodes to the additional stator terminal of the selector switch 14 from the set input terminals of M flip-flops and connections through diodes to the same stator terminal of the selector switch 14 from the reset input terminals of N-M flip-flops.

In some embodiments of this invention, a first group of mass storage units is connected at all times the system is in operation; and one or more of the remaining mass storage units in the system are identified to be connected and the remainder disconnected as described above.

Thus, it is seen that in some preferred embodiments this invention comprises a system for a) selecting and connecting one or more of a multiplicity of mass storage units associated with a digital computer while disconnecting the remainder of those mass storage units, and b) preventing a change in selection after that one or more mass storage units have been connected and the remainder have been disconnected until power is removed from the system. The selection may be made by hardware, firmware, or software. The selection may be made by use of an independent switch, and it may be made by a modified power switch or by a modification of the computer shutdown/restart menu, for example.

In other embodiments, after one mass storage unit has been selected and connected, one or more other mass storage units may be connected in addition, by hardware, firmware, or software, while at least one additional mass storage unit is left disconnected. This can be done, for example, by modifying the computer's BIOS and/or its configuration file, or by adding a second switch, to be actuated at some time after the first mass storage unit has been connected.

In still other embodiments of this invention, a digital computer is booted in the conventional way with multiple mass storage units connected; then, at a later time, one or more of the mass storage units are disabled in an orderly manner so as to prevent loss of data and/or damage to software, while the remaining mass storage units remain enabled, with rebooting if necessary on one of the mass storage units not disconnected. In this way it is possible, for example, to provide protection against hackers from all other users of a network and achieve total privacy of all files on the mass storage units that were disconnected. As a result, the disconnected mass storage units are protected from viruses, worms, and all other forms of harmful intrusion transmitted over the network while still allowing uninhibited use of the network on the mass storage units that remain connected.

The connecting of one group of mass storage units and the disconnecting of others may be accomplished by hardware, firmware, or software. This can be done, for example, by modifying the computer's BIOS and/or its configuration file and using a software switch, or by adding a second switch, to be actuated at some time after the first mass storage unit has been enabled.

In still other embodiments of this invention, a first multiplicity of mass storage units may be connected without switching, and a second multiplicity of mass storage units may be connected by switching, as described previously.

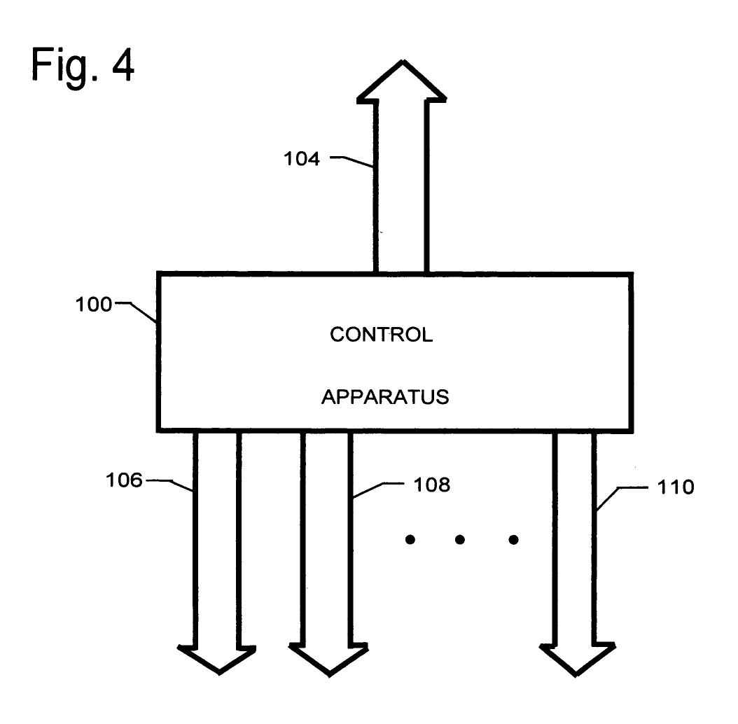

An example of an assembly without a mass memory unit, which is nevertheless encompassed by this invention, is illustrated in FIG. 4. Control apparatus 100 serves to interface a multiplicity of mass storage units such as drive 0 58 in FIG. 3, drive 1 60 in FIG. 3, . . . , and drive N-1 62 in FIG. 3 to the appropriate data bus in a digital computer. The control apparatus 100, which comprises the main connecting apparatus 103 shown in FIG. 1 and may comprise also the selection apparatus 101 shown in FIG. 1 and the second connecting apparatus 109 shown in FIG. 3, is connected to the appropriate data bus in the digital computer by connecting apparatus N 104, which may comprise a connector to simplify connection and removal. Similarly, the control apparatus 100 is connected to the data bus on hard disk drive 0 58 in FIG. 3 by connecting apparatus 106, which may contain a connector to facilitate connection to hard disk drive 0 58, to the data bus on hard disk drive 1 60 in FIG. 3 by connecting apparatus 108, which may contain a connector to facilitate connection to hard disk drive 1 60, . . . , and to the data bus on hard disk drive N-1 62 in FIG. 3 by connecting apparatus 110, which may contain a connector to facilitate connection to hard disk drive N-1 62. The ground connections to hard disk drive 0 58, hard disk drive 1 60, . . . , and hard disk drive N-1 62 may extend directly from connecting apparatus N 104 to the hard disk drive connecting apparatus 106 for drive 0 58, the connecting apparatus 108 for drive 1 60, . . . , and the connecting apparatus 110 for drive N-1 62; or the ground connections may pass through the control apparatus 100.

As has been mentioned above, one highly desirable aspect of this invention is that it provides privacy from other users of a common digital computer. Such privacy can be obtained by cooperation among users, but it can be assured, if desired, by provision of a locking device, which may be a simple keyswitch, an electronic circuit, a mechanical lock, or a combination of these, for example.

Another embodiment of this invention implements hardware dual booting of a computer, as described below.

Hard disk drives designed to be configurable either as a master or as a slave can be used to create a master-slave system in which a particular hard disk drive can be selected to be the master, with the remainder of the hard disk drives in the system operating as slaves. This can be accomplished by selecting at the time that power is applied to the system only the hard disk drive intended to be the master, and then connecting the drive or drives intended to be slaves after the computer system has booted. A time delay can be incorporated in the switching circuit to provide automatic connection of the slave drives sufficiently later than the master to ensure that booting has been completed, a separate switch can be provided for manual initiation of the connection of the slave drives, or other means known to one of ordinary skill in the art may be used. All of the hard disk drives are configured as a master or, where required, a master without a slave, by use of the jumpers provided on the hard disk drives for that purpose.

In a computer system in which two hard disk drives are connected by daisy chain to a single port, master/slave status of the hard disk drives can be reversed by a switching circuit that interchanges the conductor in the data bus for one hard disk drive that signals master/slave status to the host computer with the corresponding conductor in the data bus for the other hard disk drive. Provision may be made to inhibit switching except at the time that power is applied, as indicated previously.

The following alternative embodiment for hardware dual booting is particularly applicable to serial ATA hard disk drives, but can be used with other kinds of mass storage units for which multiple ports are provided in a computer.

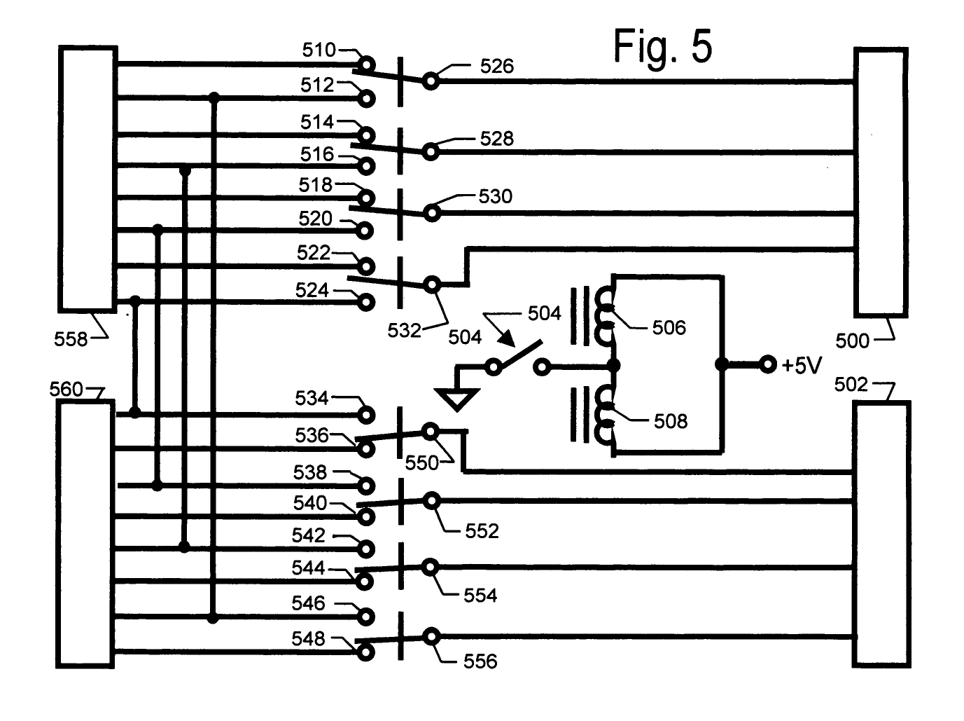

Although serial ATA drives cannot be configured as master or slave, they can be operated as master or slave depending on the computer port to which they are connected. That is, the drive connected to the earliest host port in the boot sequence operates as master, and a drive connected to a later port in the boot sequence operates as a slave. Consequently, dual booting can be achieved by providing means for interchanging the ports to which the drives are connected. One example of such a system is illustrated in FIG. 5.

Although no means are shown for inhibiting switching at times other than the time at which power is applied to the circuit, inhibiting means may be added. A resistor-capacitor charging circuit and a flip-flop may be used for that purpose, for example, as shown in FIG. 2, as may other means disclosed herein and other means known to those skilled in the art.

Additional protection against switching the master/slave status of the first serial ATA hard disk drive 500 and the second serial ATA hard disk drive 502 improperly can be provided, if desired, by ensuring that the power supply for the switching circuit maintains its output voltage longer than the power supply for the two serial ATA hard disk drives 500 and 502 when the system is shut down. This can be done even if the power for the switching circuit is derived from the power supply for the hard disk drives, by use of a half-wave rectifier comprising a rectifier diode and a capacitor of large capacitance to obtain the operating voltage for the switching circuit from the operating voltage for the hard disk drives, for example.

Although connecting/disconnecting both host transmit lines and both host receive lines is illustrated, connecting/disconnecting only one line of each pair or other combinations of the lines is encompassed also by this invention.

In FIG. 5, a first serial ATA hard disk drive 500 and a second serial ATA hard disk drive 502 are shown, together with a first connector 558 for connection to a first host port and a second connector 560 for connection to a second host port. The two serial ATA hard disk drives 500 and 502 are connected to and disconnected from the two connectors 558 and 560 by a first set of contacts 510, 512, 514, 516, 518, 520, 522, 524, 526, 528, 530, and 532, on a first relay comprising those contacts and a first relay coil 506, and a second set of contacts 534, 536, 538, 540, 542, 544, 546, 548, 550, 552, 554, and 556 on a second relay comprising those contacts and a second relay coil 508.

The coil 506 of the first relay and the coil 508 of the second relay 508 are connected in parallel. Switching of the connections to the first serial ATA hard disk drive 500 and the second serial hard disk drive 502 is initiated by actuating a single-pole, single-throw switch 504. In its open state, the switch 504 isolates the relay coils 506 and 508 from the power supply, causing the contacts on the two relays 506 and 508 to remain in their normal states, in which the first serial ATA hard disk drive 500 is connected to the first connector 558 and the second serial ATA hard disk drive 502 is connected to the second connector 560. The host port connected to the first connector 558 appears earlier in the boot sequence of the host than does the host port connected to the second connector 560. Consequently, the first serial ATA hard drive 500 operates as a master and the second serial ATA hard drive 502 operates as a slave.

When the switch 504 is closed, the coils 506 and 508 of the two relays are connected to the power supply. The resulting currents in the relay coils 506 and 508 cause the relays to be actuated, with the result that the first serial ATA hard disk drive 500 is disconnected from the first connector 558 and connected to the second connector 560, and the second serial ATA hard disk drive 502 is disconnected from the second connector 560 and connected to the first connector 558. Because the host port that is connected to the first connector appears earlier in the boot sequence, the second serial ATA hard disk drive 502 then operates as a master. Because the host port that is connected to the second connector 560 appears later in the boot sequence, the first serial ATA hard disk drive 500 then operates as a slave.

Thus, hardware dual booting of the first serial ATA hard disk drive 500 and the second serial ATA hard disk drive 502 is achieved.

It will be evident to one of ordinary skill in the art that solid state electronic switching can be used instead of the relays shown in FIG. 5.

It will be evident also that it is not essential that the host ports to which the two serial ATA hard disk drives are connected be interchanged. It is necessary only that the switching be to ports with a reversed boot sequence.

Other embodiments of this invention do not include one of the hard disk drives in some cases; and neither the first serial ATA hard disk drive 500 nor the second serial ATA hard disk drive 502 is included in some other cases. In those embodiments, one or both hard disk drives must be obtained separately to connect to the switching circuit.

In each case, use of a particular one of the two hard disk drives as a master can be inhibited by use of a lock. Such a lock can be used to prevent the connecting of a particular one of the two serial ATA hard disk drives 500 and 502 to a port that appears earlier in the host boot sequence than the other one of the two serial ATA hard disk drives. The locking device may be hardware, software, firmware, or a combination thereof, or a mechanical lock may be used. A keyswitch is a particularly simple device for providing such security. As in the earlier example, various kinds of lock suitable for use with the system illustrated in FIG. 5 will be known to one of ordinary skill in the art.

It will be obvious also that protection against switching the connections to the two hard disk drives 500 and 502 shown in FIG. 5 except at the time power is applied to the circuit can be incorporated in the circuit, using any of the means disclosed above or other means known to one of ordinary skill in the art.

Although the invention disclosed herein has been described with reference to specific embodiments, various modifications and improvements will occur to those skilled in the art. It is to be understood, therefore, that this invention is not limited to the particular forms illustrated, nor to particular devices known at present, but includes all arrangements of apparatus that do not depart from the spirit and scope of the appended claims and encompasses all specific devices now known or to be developed in the future that can be used as described herein.

The essence of the invention is the use of a switching circuit that provides for changes in the connections of data lines of mass storage units to appropriate data buses or ports in a host. The determination of the connections to exist at any given time may be made by hardware or by firmware or software. Not every embodiment necessarily comprises the hard disk drives themselves. In some embodiments, neither hard disk drive is included. In some other embodiments, one of the hard disk drives is a primary hard disk drive, regarded as a part of another digital system itself, while another hard disk drive is a part of the apparatus disclosed by this invention. In still other embodiments, all of the hard disk drives are parts of the apparatus disclosed by this invention.

To avoid complexity in expression, the previous discussions have been restricted to the connecting and disconnecting of individual mass storage units. This invention encompasses also the connecting and disconnecting of multi-disk or multi-port controllers, however.

Although specific examples have been given with reference to IBM or IBM-compatible personal computers, other computers may be used as well, in particular computers with a plug and play capability. Both general-purpose computers and special-purpose computing systems, such as reservation systems, multipurpose telephones, multipurpose DVD players, multipurpose television receivers, and others are encompassed by the disclosures herein contained.

Variations in design without departing from the spirit and scope of this invention are encompassed by the claims appended below.

What I claim as my invention is:

1. Apparatus for selecting and connecting one or more of a multiplicity of mass storage units and disconnecting the remainder of said multiplicity of mass storage units or ensuring that they are not connected, comprising:
(a) a selection device for identifying which one or more of said multiplicity of mass storage units are to be connected; and
(b) apparatus for connecting the one or more of said multiplicity of mass storage units that are so identified and disconnecting those of said multiplicity of mass storage units that are not so identified or ensuring that they are not connected.

2. Apparatus for selecting and connecting one or more of a multiplicity of mass storage units and disconnecting the remainder of said multiplicity of mass storage units or ensuring that they are not connected as claimed in claim 1 further comprising apparatus to inhibit a change in the identification of said one or more of said multiplicity of mass storage units that are to be connected except during a short time interval immediately following the instant at which power is made available or apparatus to inhibit a change in the connecting or disconnecting of those of said multiplicity of mass storage units that are not so identified except during a short time interval immediately following the instant at which power is made available.

3. Apparatus for selecting and connecting one or more of a multiplicity of mass storage units and disconnecting the remainder of said multiplicity of mass storage units or ensuring that they are not connected as claimed in claim 1, wherein the mass storage units in a subset of said one or more of said multiplicity of mass storage units are identified to be connected at all times the system is in operation, regardless of which other mass storage units are connected at any given time.

4. Apparatus for selecting and connecting one or more of a multiplicity of mass storage units and disconnecting the remainder of said multiplicity of mass storage units or ensuring that they are not connected as claimed in claim 1, wherein:
(a) the mass storage units in a subset of said one or more of said multiplicity of mass storage units are identified to be connected at all times the system is in operation, regardless of which other mass storage units are connected at any given time; and
(b) changes in the identification of said one or more of a multiplicity of mass storage units that are to be connected are inhibited except during a short time interval immediately following the instant at which power is made available or changes in the connecting or disconnecting of those of said mass storage units that are not so identified are inhibited except during a short time interval immediately following the instant at which power is made available.

5. Apparatus for selecting and connecting one or more of a multiplicity of mass storage units and disconnecting the remainder of said multiplicity of mass storage units or ensuring that they are not connected as claimed in claim 1 further comprising a locking device for limiting access to one or more of said multiplicity of mass storage units.

6. Apparatus for selecting and connecting one or more of a multiplicity of mass storage units and disconnecting the remainder of said multiplicity of mass storage units or ensuring that they are not connected as claimed in claim 1 wherein:
(a) changes in the identification of said one or more of said multiplicity of mass storage units that are to be connected are inhibited except during a short time interval immediately following the instant at which power is made available or changes in the connecting or disconnecting of those of said multiplicity of mass storage units that are not so identified are inhibited except during a short time interval immediately following the instant at which power is made available; and
(b) a locking device is provided for limiting access to one or more of said multiplicity of mass storage units.

7. A selectable mass storage system comprising:
(a) one or more mass storage units;
(b) selection apparatus for identifying the one or more of said one or more mass storage units that are to be connected; and
(c) apparatus for connecting said one or more of said one or more mass storage units that are so identified and disconnecting those of said one or more mass storage units that are not so identified or ensuring that they are not connected.

8. A selectable mass storage system as claimed in claim 7 further comprising apparatus to inhibit changes in the identification of said one or more of said one or more mass storage units that are to be connected except during a short time interval immediately following the instant at which power is made available or apparatus to inhibit changes in the connecting or disconnecting of said one or more of said one or more mass storage units that are not so identified except during a short time interval immediately following the instant at which power is made available.

9. A selectable mass storage system as claimed in claim 7 wherein the mass storage units in a subset of said one or more mass storage units are identified to be connected at all times the system is in operation, regardless of which other mass storage units are connected at any given time.

10. A selectable mass storage system as claimed in claim 7 further comprising a locking device for limiting access to one or more of said one or more mass storage units.

11. A selectable mass storage system as claimed in claim 7 wherein said selection apparatus for identifying said one or more of said one or more mass storage units that are to be connected comprises computer code.

12. A selectable mass storage system as claimed in claim 7 further comprising:
(a) apparatus to inhibit changes in the identification of said one or more of said one or more mass storage units that are to be connected except during a short time interval immediately following the instant at which power is made available or apparatus to inhibit changes in the connecting or disconnecting of said one or more of said one or more mass storage units that are not so identified except during a short time interval immediately following the instant at which power is made available; and
(b) a locking device for limiting access to one or more of said one or more mass storage units.

13. Apparatus for determining which of at least two mass storage units is to be the master while the remainder of said at least two mass storage units are to be slaves, comprising:
(a) a selection device for identifying which of said at least two mass storage units is to be the master; and
(b) a switching circuit that performs the function of switching at least one data line on each of said at least two mass storage units.

14. Apparatus for determining which of at least two mass storage units is to be the master while the remainder of said at least two mass storage units are to be slaves as claimed in claim 13, further comprising locking apparatus for preventing the connecting of at least one of said at least two mass storage units as a master.

15. Apparatus for determining which of at least two mass storage units is to be the master while the remainder of said at least two mass storage units are to be slaves as claimed in claim 13, further comprising apparatus to inhibit a change in the master/slave status of any of said at least two mass storage units except during a short interval of time immediately following the time at which power is made available.

16. Apparatus for determining which of at least two mass storage units is to be the master while the remainder of said at least two mass storage units are to be slaves as claimed in claim 13, further comprising at least one of said at least two mass storage units.

17. Apparatus for determining which of at least two mass storage units is to be the master while the remainder of said at least two mass storage units are to be slaves as claimed in claim 13, further comprising:
(a) at least one of said at least two mass storage units; and
(b) apparatus to inhibit a change in the master/slave status of any of said at least two mass storage units except during a short interval of time immediately following the time at which power is made available.

18. Apparatus for determining which of at least two mass storage units is to be the master while the remainder of said at least two mass storage units are to be slaves as claimed in claim 13, further comprising:
(a) locking apparatus for preventing the connecting of at least one of said at least two mass storage units as a master; and
(b) apparatus to inhibit a change in the master/slave status of any of said at least two mass storage units except during a short interval of time immediately following the time at which power is made available.

19. Apparatus for determining which of at least two mass storage units is to be the master while the remainder of said at least two mass storage units are to be slaves as claimed in claim 13, further comprising:
(a) at least one of said at least two mass storage units; and
(b) locking apparatus for preventing the connecting of at least one of said at least two mass storage units as a master.

20. Apparatus for determining which of at least two mass storage units is to be the master while the remainder of said at least two mass storage units are to be slaves as claimed in claim 13, further comprising:
(a) at least one of said at least two mass storage units;
(b) locking apparatus for preventing the connecting of at least one of said at least two mass storage units as a master; and
(c) apparatus to inhibit a change in the master/slave status of any of said at least two mass storage units except during a short interval of time immediately following the time at which power is made available.
